(19) United States
(12) Patent Application Publication
(10) Pub. No.: US 2008/0174503 A1
(43) Pub. Date: Jul. 24, 2008

(54) ANTENNA AND ELECTRONIC EQUIPMENT HAVING THE SAME

(75) Inventors: Moon-Il KIM, Seoul (KR); Kook-Joo LEE, Seoul (KR); Hong-Teuk KIM, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/966,775

(22) Filed: Dec. 28, 2007

(30) Foreign Application Priority Data
Dec. 29, 2006 (KR) 10-2006-0139072
Dec. 29, 2006 (KR) 10-2006-0139073
Dec. 29, 2006 (KR) 10-2006-0139074

(51) Int. Cl. H01Q 1/00; H01Q 9/16

(52) U.S. Cl. 343/722; 343/793

(57) ABSTRACT

An antenna and electronic equipment having the same are disclosed. The antenna comprises: a radiator electrically connected to a feeder, and radiating an electric wave; and one or more reinforcing circuits disposed in the radiator so as to uniformly distribute a current on at least one part of the radiator. The antenna can have a length much shortened than a wavelength of an operation frequency with maintaining the same efficiency, thereby being able to be mounted even in electronic equipment such as a terrestrial DMB terminal operated at a low frequency bandwidth,

### RELATED APPLICATION

The present disclosure relates to subject matter contained in priority Korean Application No. 10-2006-0139072 filed on Dec. 29, 2006, No. 10-2006-0139073 filed on Dec. 29, 2006, and No. 10-2006-0139074 filed on Dec. 29, 2006, which are herein expressly incorporated by reference in its entirety.

### BACKGROUND OF THE INVENTION

1. Field of the Invention

The present disclosure relates to an antenna for transmitting/receiving an electric wave and electronic equipment having the same.

2. Description of the Background Art

Electronic equipment having communication means therein serves to reproduce received electric waves, or serves to transmit signals generated therefrom in an electric wave form. The electronic equipment includes portable phones, PDAs (Personal Digital Assistants), car navigators, notebook computers, data recording, reproducing and displaying machines, electronic dictionaries, MP3 players, MD players, radios, audio, etc.

The electronic equipment has to be provided not only with excellent specific functions, but also various designs for satisfying consumers' demands.

In order to meet the consumers' demand for a slim design, research for mounting an antenna protruding from the electronic equipment with a long length in the electronic equipment is being actively performed.

Generally, a dipole antenna resonates at a half wavelength of a wavelength of an operation frequency. Accordingly, an antenna operated at a high frequency bandwidth can be mounted in the electronic equipment due to its short length. However, an antenna having an operation frequency of a low bandwidth (174˜216 MHz) so as to be mounted at electronic equipment such as a DMB (Digital Multimedia Broadcasting) terminal, has to have a long length for resonation, the length too long to be mounted in the electronic equipment. For instance, in case of electronic equipment having an operation frequency of 200 MHz, the dipole antenna applied thereto has to have a length of 75 cm. Therefore, the electronic equipment for transmitting and receiving electric waves of a low frequency bandwidth has to be provided with an external antenna such as a retractable antenna.

Recently, research for installing an antenna miniaturized to transmit and receive electric signals of a low frequency bandwidth in the electronic equipment is being actively performed. However, when the antenna has a decreased size, a bandwidth, a gain or efficiency of the antenna are degraded. Accordingly, the technique for mounting an antenna having a low frequency bandwidth in the electronic equipment has not been practicalized.

Furthermore, an antenna applied to a portable terminal is fabricated by cutting and bending a conductive plate, thereby lowering precision in size and requiring complicated fabrication processes.

### SUMMARY OF THE INVENTION

Therefore, an object of the present disclosure is to provide an antenna capable of more enhancing efficiency than an antenna of the same size, and electronic equipment having the same.

Another object of the present disclosure is to provide an antenna capable of reducing a size thereof with maintaining the same efficiency, and electronic equipment having the same.

Still another object of the present disclosure is to provide an antenna capable of enhancing efficiency with a reduced size and broadening a bandwidth, and electronic equipment having the same.

To achieve these and other advantages and in accordance with the purpose of the present disclosure, as embodied and broadly described herein, there is provided all antenna, comprising: a radiator electrically connected to a feeder, and radiating an electric wave; and one or more reinforcing circuits disposed in the radiator so as to uniformly distribute a current on at least one part of the radiator.

According to another aspect of the present invention, there is provided a dipole antenna, comprising: first and second dipole arms electrically connected to a feeder, and having different potentials from each other; and a reinforcing circuit electrically connected to at least one of the first and second dipole arms so as to uniformly distribute a current on at least one of the first and second dipole arms.

According to still another aspect of the present invention, there is provided a lamination-type antenna, comprising: a chip body; a radiator formed at the chip body, and electrically connected to a feeder; and a reinforcing circuit disposed in the radiator so as to uniformly distribute a current onto at least one part of the radiator.

According to yet still another aspect of the present invention, there is provided a monopole antenna, comprising: a radiator electrically connected to a feeder, and disposed on a ground plane of a finite plane; and a reinforcing circuit disposed in the radiator so as to uniformly distribute a current on at least one part of the radiator, and connected to the ground plane.

To achieve these and other advantages and in accordance with the purpose of the present disclosure, as embodied and broadly described herein, there is also provided electronic equipment having an antenna for transmitting and receiving an electric wave, wherein the antenna comprises a radiator electrically connected to a feeder, and radiating an electric wave; and one or more reinforcing circuits disposed in the radiator so as to uniformly distribute a current on at least one part of the radiator.

In the present invention, the antenna can have a size much reduced than a wavelength of an operation frequency with maintaining the same efficiency, and thus can be mounted in electronic equipment such as a terrestrial DMB terminal operated at a low frequency bandwidth.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a conceptual view schematically showing an antenna according to a first embodiment of the present invention;

FIG. 2 is a graph schematically showing a reflection coefficient of the antenna of FIG. 1;

FIG. 3 is a conceptual view schematically showing a current distribution on a dipole antenna having a length shorter than a wavelength of an operation frequency;

FIG. 4 is a conceptual view schematically showing a current distribution on the antenna of FIG. 1;

FIG. 5 is a graph comparing a current distribution on the antenna of FIG. 3 with a current distribution on the antenna of FIG. 4;

FIG. 6 is a graph schematically showing a reflection coefficient of the antenna of FIG. 1 according to a radiation resistance;

FIG. 7 is an equivalent circuit of an antenna having an impedance matching unit on a transmitting line;

FIG. 8 is an equivalent circuit of the antenna of FIG. 1;

FIG. 9 is a graph comparing reflection coefficients of the antennas of FIGS. 7 and 8 with each other;

FIG. 10 is a schematic view showing a method for fabricating the antenna of FIG. 1, which shows a method for connecting an inductor to a radiator of the antenna of FIG. 1;

FIG. 11 is a conceptual view schematically showing an antenna according to a second embodiment of the present invention;

FIG. 12 is a conceptual view schematically showing an antenna according to a third embodiment of the present invention;

FIG. 13 is a conceptual view schematically showing an antenna according to a fourth embodiment of the present invention;

FIG. 14 is a conceptual view schematically showing an antenna according to a fifth embodiment of the present invention;

FIG. 15 is a conceptual view schematically showing an antenna according to a sixth embodiment of the present invention;

FIG. 16 is a conceptual view schematically showing an antenna according to a seventh embodiment of the present invention;

FIG. 17 is a conceptual view schematically showing an antenna according to an eighth embodiment of the present invention;

FIG. 18 is a detail view showing a part ‘A’ of FIG. 17;

FIG. 19 is a perspective view schematically showing a lamination-type antenna according to a ninth embodiment of the present invention;

FIG. 20 is a perspective view showing a main part of the lamination-type antenna of FIG. 19;

FIG. 21 is a sectional view schematically showing the lamination-type antenna of FIG. 19;

FIG. 22 is a perspective view showing processes for fabricating the lamination-type antenna of FIG. 19;

FIG. 23 is an equivalent circuit of the lamination-type antenna of FIG. 19,

FIG. 24 is a conceptual view schematically showing a monopole antenna according to a tenth embodiment of the present invention;

FIG. 25 is a conceptual view schematically showing a monopole antenna according to an eleventh embodiment of the present invention;

FIG. 26 is a conceptual view schematically showing a monopole antenna according to a twelfth embodiment of the present invention;

FIG. 27 is a conceptual view schematically showing a monopole antenna according to a thirteenth embodiment of the present invention;

FIG. 28 is a conceptual view schematically showing a monopole antenna according to a fourteenth embodiment of the present invention;

FIG. 29 is a detail view showing a part of ‘B’ of FIG. 28;

FIG. 30 is a conceptual view schematically showing a monopole antenna according to a fifteenth embodiment of the present invention; and

FIG. 31 is a view schematically showing that the antenna of the present invention is mounted in electronic equipment.

### DETAILED DESCRIPTION OF THE INVENTION

Reference will now be made in detail to the preferred embodiments of the present disclosure, examples of which are illustrated in the accompanying drawings.

Hereinafter, an antenna and electronic equipment having the same according to the present invention will be explained in more detail with reference to the attached drawings.

Referring to FIG. 1, the antenna according to a first embodiment of the present invention is a dipole antenna, and comprises a radiator 101 electrically connected to a feeder 100, and one or more reinforcing circuits 104 disposed in the radiator 101 so as to uniformly distribute a current on at least one part of the radiator 101.

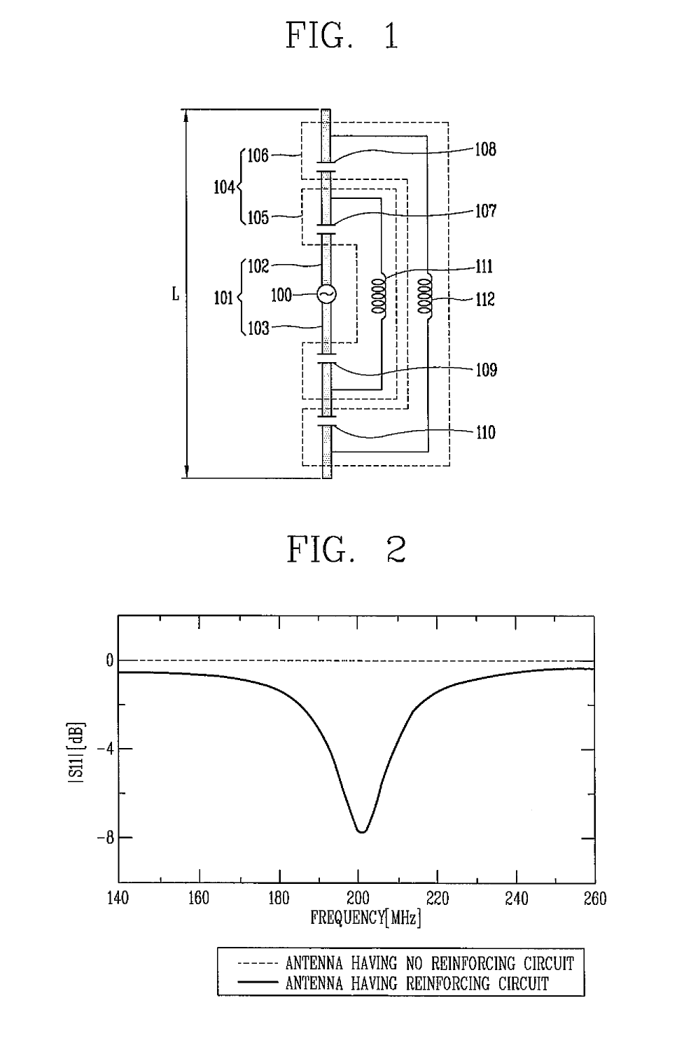

The radiator 101 includes first and second dipole arms 102,103 each formed of a conductive material and electrically connected to the feeder 100. Voltages (potentials) of the first and second dipole arms 102, 103 each supplied from the feeder 100 have a phase difference of approximately 180° therebetween. A total length of the first and second dipole arms 102, 103 is about 1/20 of a wavelength of an operation frequency. Accordingly, when the first and second dipole arms 102, 103 have no reinforcing circuit 104, a resonance does not occur near an operation frequency (200 MHz) as shown by the dotted line of FIG. 2.

The first and second dipole arms 102, 103 may be implemented as linear conductors such as wires. However, the first and second dipole arms 102, 103 may be implemented as various types of conductors unless widths of the conductors influence on a proceeding of a current.

The reinforcing circuit 104 serves to increase an amount of current applied to the first and second dipole arms 102,103, and to uniformly distribute a current on the first and second dipole arms 102, 103. The reinforcing circuit 104 is periodically arranged on the first and second dipole arms 102,103 in plurality in number. In the preferred embodiment, two reinforcing circuits 105,106 are implemented.

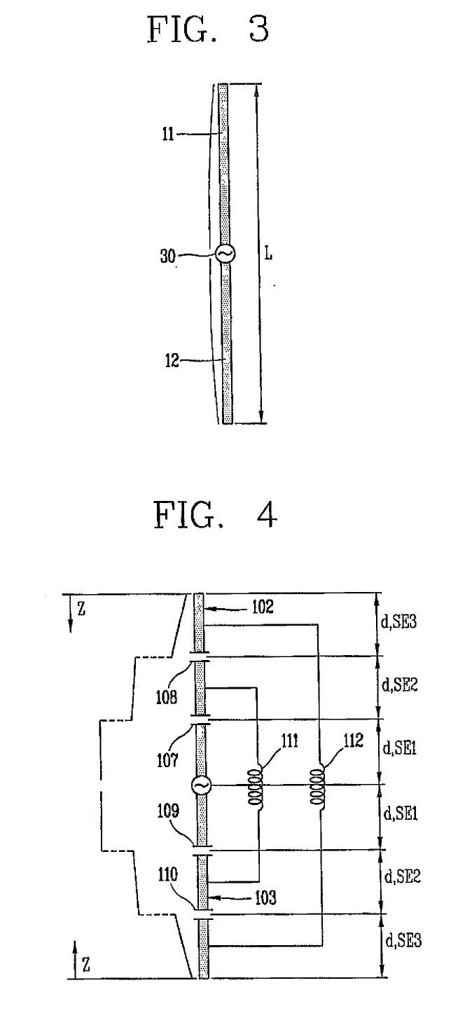

The reinforcing circuits 105,106 include first and second capacitors 107,108 disposed on the first dipole arm 102 with a certain gap (d) therebetween (refer to FIG. 3), third and fourth capacitors 109,110 disposed on the second dipole arm 103 with the same gap (d) therebetween (refer to FIG. 3) in correspondence to the first and second capacitors 107,108, and first and second inductors 111,112 each having both ends connected to the first and second dipole arms 102,103.

The first to fourth capacitors 107,108,109,110 preferably have the same capacitance, but may have different capacitance for impedance matching. The first to fourth capacitors 107,108,109,110 are arranged with a certain gap (d) therebetween, but may have a different gap therebetween so as to optimize an antenna function.

The first inductor 111 has one end connected to the first dipole arm 102 between the first and second capacitors 107,108, and another end connected to the second dipole arm 103 between the third and fourth capacitors 109,110. As aforementioned, the first and second dipole arms 102,103 have different potentials from each other. Accordingly, the first inductor 111 having both ends respectively connected to the first and second dipole arms 102,103 are connected to different potentials, thereby serving as a reactance on an equivalent circuit as shown in FIG. 8.

The second inductor 112 has one end connected between the second capacitor 108 and one end of the first dipole arm 102, and another end connected between the fourth capacitor 110 and one end of the second dipole arm 103. Both ends of the second inductor 112 are connected to different potentials in the same manner as the first inductor 111, thereby serving as a reactance on an equivalent circuit as shown in FIG. 8.

The first and second inductors 111,112 preferably have the same inductance, but may have different inductance so as to optimize an antenna function.

As the capacitors 107,108,109,110 and the inductors 111,112, lumped elements are preferably used. However, distributed elements having varied sizes such as microstrips may be used.

In the preferred embodiment, the dipole antenna having the two reinforcing circuits 105,106 is implemented. However, the dipole antenna having three or more reinforcing circuits 105,106 may be implemented.

FIG. 2 is a graph schematically showing a reflection coefficient (S11) of the antenna of FIG. 1.

As indicated by the solid line of FIG. 2, the dipole antenna resonates at an operation frequency (200 MHz). However, as indicated by the dotted line of FIG. 2, the antenna having no reinforcing circuit 104 of FIG. 3 does not resonate at the operation frequency (200 MHz). The reason is because the reflection coefficient (S11) of the antenna having no reinforcing circuit 104 was measured with a length (7.5 cm) corresponding to 1/20 of a wavelength of the operation frequency (200 MHz), not with a half wavelength (75cm) of a wavelength of the operation frequency (200 MHz). However, the dipole antenna of FIG. 1 having the length (L: 7.5 cm) corresponding to 1/20 of a wavelength of the operation frequency (200 MHz) can resonate at the operation frequency (200 MHz) by arranging the reinforcing circuit 104 in the radiator 101, the reinforcing circuit having the capacitors 107,109,109, 110 and the inductors 111,112. A resonance frequency is determined by the reinforcing circuit 104, especially, the capacitors 107,108,109,110 and the inductors 111,112 disposed on the first and second dipole arms 102,103, regardless of an antenna length.

As aforementioned, the dipole antenna having a length much shorter than a wavelength of the operation frequency (200 MHz) can resonate at the operation frequency by the reinforcing circuit 104, and can reduce a size of an antenna of a low frequency bandwidth (less than 1 GHz) to a length short enough to be mounted in a general portable terminal. However, even if the dipole antenna having a length much shorter than a wavelength of the operation frequency (200 MHz) can resonate at the operation frequency by disposing the capacitors 107,108,109,110 and the inductors 111,112, the antenna can not be practicalized even if a gain, efficiency, and a bandwidth thereof are lowered. Here, the gain and efficiency of the antenna are closely related to a current distribution and a radiation resistance. Accordingly, a current amount, a current distribution, and a radiation resistance of the dipole antenna of FIG. 1 will be explained.

FIG. 3 is a conceptual view schematically showing a current distribution on a dipole antenna having no reinforcing circuit 104, and having a length (L) corresponding to 1/20 of a wavelength of an operation frequency.

As shown, since both ends of the dipole antenna are opened, a resistance applied to the both ends becomes unlimited thus to have a current value of ‘0’. A current distribution is shown with a sine form from both ends of the first and second dipole arms 101,104 to the feeder 30. However, since the length of the first and second dipole arms 101,104 is short enough to be about 1/20 of a wavelength of an operation frequency, a current distribution on the first and second dipole arms 101,104 is shown near ‘0’.

However, as shown in FIG. 4, in the dipole antenna having the reinforcing circuit 104, an amount of current applied to the first and second dipole arms 102, 103 is increased, and current is uniformly distributed to each section SE1, SE2, SE3 based on the capacitors 107,108,109,110. The reason is because characteristics of the first and second dipole arms 102,103 are changed by the reinforcing circuit 104. More concretely, a phase constant becomes ‘0’ at a specific frequency by arranging the capacitors 107,108,109,110 and the inductors 111, 112, and by tuning each capacitance and inductance. As the phase constant becomes closer to ‘0’, current is uniformly distributed in each section SE1, SE2, SE3 of the first and second dipole arms 102,103.

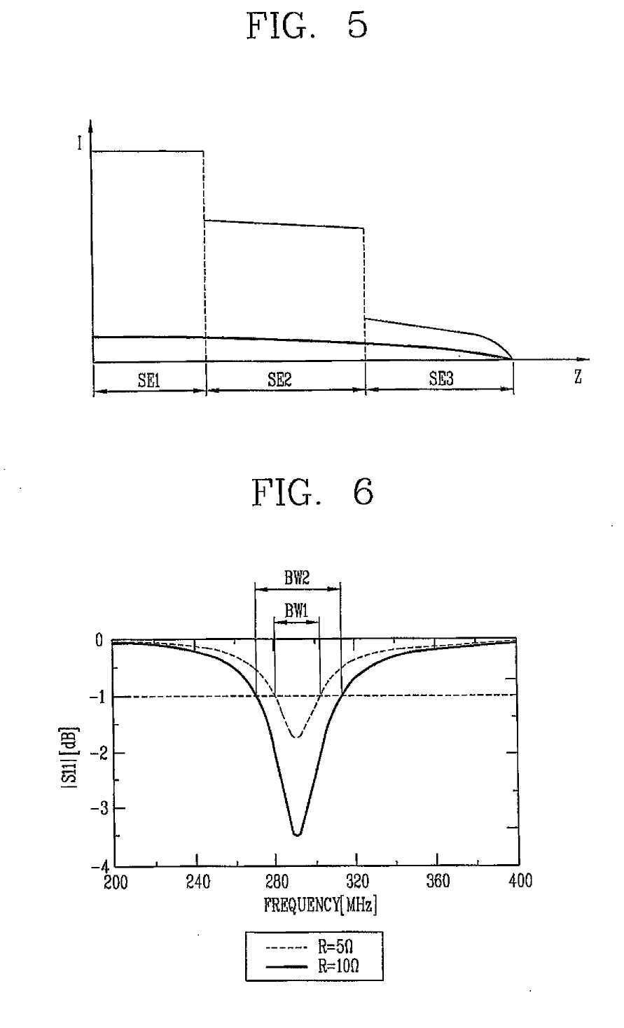

FIG. 5 is a graph comparing a current distribution on the dipole antenna of FIG. 3 with a current distribution on the antenna of FIG. 4. As shown, the dipole antenna of FIG. 3 has a current decreased towards one end thereof from the feeder 100 (a sine form theoretically, but a straight line due to a very short length of the dipole antenna). However, in the dipole antenna of FIG. 4, an amount of current is drastically decreased on each interface among the sections SE1, SE2, SE3, but current is uniformly distributed to the respective sections SE1, SE2, SE3. Since the current is uniformly distributed to the respective sections SE1, SE2, SE3, a radiation resistance of the antenna is increased, thus a radiation power is increased, and thus efficiency of the antenna is enhanced.

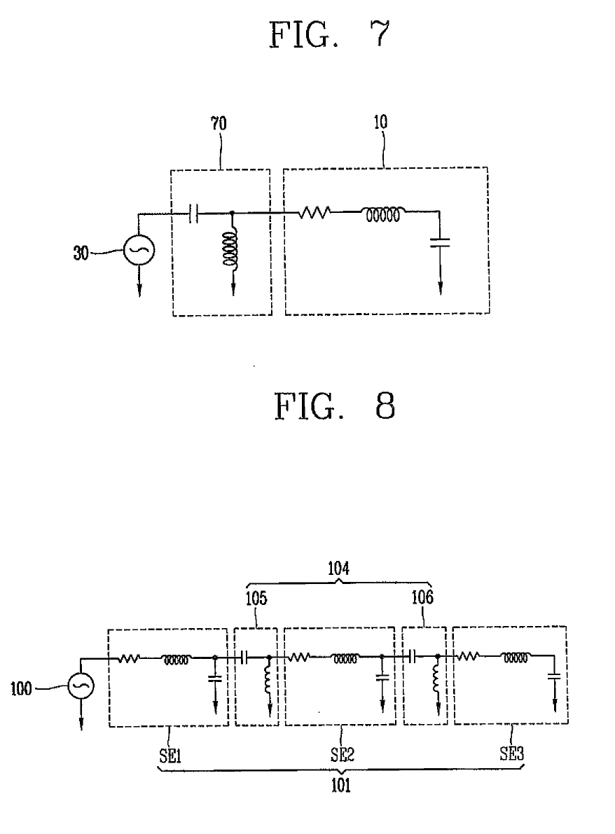

FIG. 6 is a graph schematically showing a reflection coefficient (S11) of the antenna of FIG. 1 according to a radiation resistance (R) varied by arranging the capacitors 107,108,109,110 and the inductors 111,112, and by turning each capacitance and inductance. Referring to FIG. 6, the radiation resistance (R) of 10(Ω) has a bandwidth (BW2) widened than a bandwidth (BW1) of the radiation resistance (R) of 5(Ω). As the radiation resistance (R) is increased, the reflection coefficient (S11) is lowered. In the first embodiment of the present invention, the radiation resistance (R) is increased to widen the bandwidth (BW2), and the radiation coefficient (S11) is lowered according to increase of the radiation resistance (R). Accordingly, efficiency of the antenna is more enhanced.

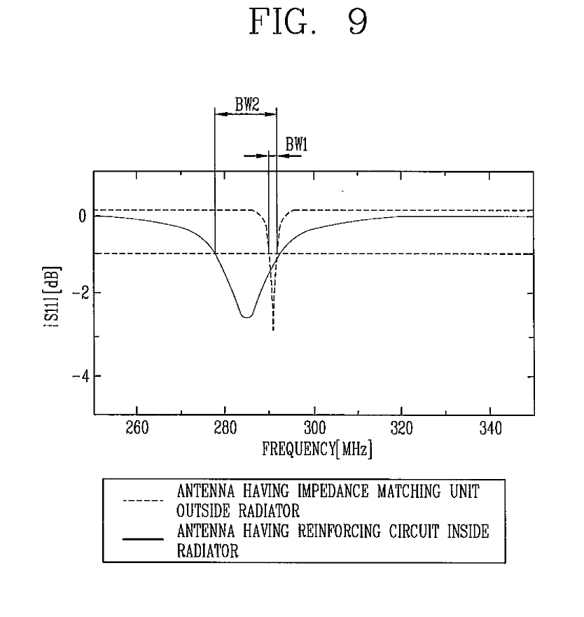

FIG. 7 is an equivalent circuit of an antenna having an impedance matching unit 70 on a transmitting line between the feeder 30 and the radiator 10, FIG. 8 is an equivalent circuit of the dipole antenna of FIG. 1, and FIG. 9 is a graph comparing each reflection coefficient (S11) of the antennas of FIGS. 7 and 8 represented as equivalent circuits.

Referring to FIGS. 7 to 9, a bandwidth (BW2) of the antenna when the reinforcing circuit 104 is inserted into the radiator 101 is wider than a bandwidth (BW1) of the antenna when an impedance matching unit 70 is arranged outside the radiator 10. The bandwidth (BW2) of the antenna depends on each capacitance and inductance inside the reinforcing circuit 104, and each arrangement gap of the capacitors 107,108,109,110 and the inductors 111,112 (refer to FIG. 1). Accordingly, the bandwidth (BW2) can be optimum by controlling the number of the capacitors 107,108,109,110 and the inductors 111,112, and each arrangement gap therebetween, or by controlling each capacitance of the capacitors 107,108,109, 110 and each inductance of the inductors 111,112.

In summary, the current distribution can be uniformly shown on at least one part of the radiator 101 by arranging the reinforcing circuit 104 including the capacitors 107,108,109,110 and the inductors 111,112 in the radiator 101. Accordingly, the radiation resistance is increased, thereby enhancing the radiation power, the efficiency, and the bandwidth of the antenna. Furthermore, since the amount of current applied to the radiator 101 is increased by the reinforcing circuit 104, the radiation power and efficiency of the antenna are enhanced.

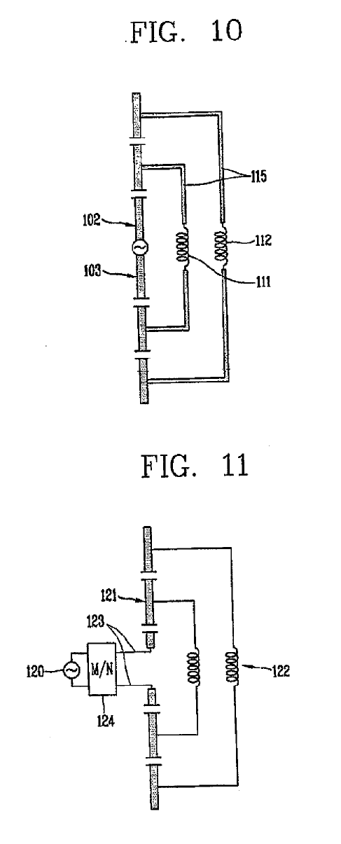

FIG. 10 is a schematic view showing a method for fabricating the dipole antenna of FIG. 1, in which the inductors 111,112 are implemented by connecting connection conductors 115 formed of the same material as the dipole arms 102,103 to the first and second dipole arms 102,103. Here, the inductors 111,112 may be implemented by connecting a stub to the first and second dipole arms 102, 103.

FIG. 11 is a conceptual view schematically showing a dipole antenna according to a second embodiment of the present invention. Referring to FIG. 11, an impedance matching unit 124 is disposed on a transmission line 123 between a feeder 120 and a radiator 121. As the impedance matching unit 124 is disposed on the transmission line 123 together with the reinforcing circuit 122, an impedance matching is optimized thus to enhance efficiency of the antenna.

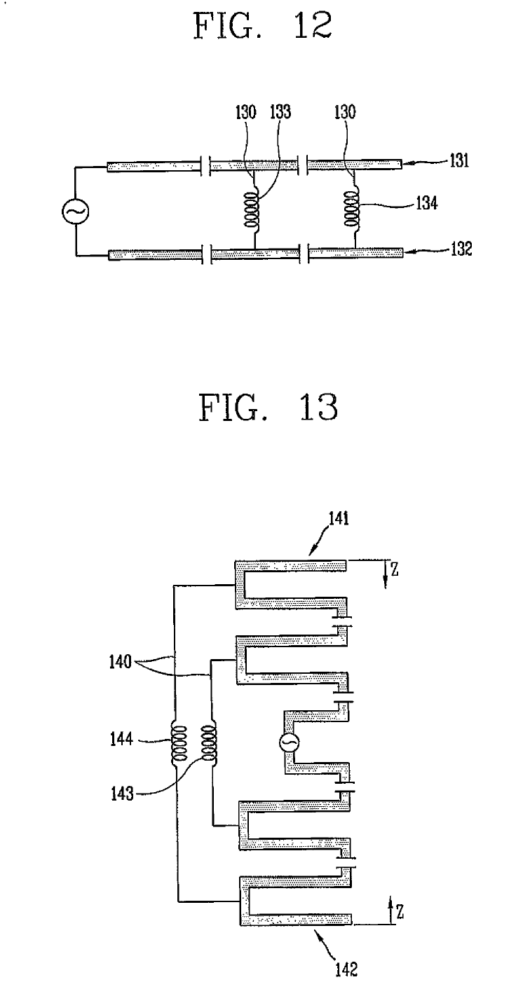

FIG. 12 is a conceptual view schematically showing a dipole antenna according to a third embodiment of the present invention. Referring to FIG. 12, since first and second dipole arms 132,132 are disposed in parallel to each other, connection conductors 130 for connecting inductors 133,134 to the first and second dipole arms 132,132 can have a minimized length. As the connection conductors 130 have a minimized length, the antenna has a reduced size, and an electromagnetic field interference due to the connection conductors 130 is decreased.

FIG. 13 is a conceptual view schematically showing an antenna according to a fourth embodiment of the present invention. Referring to FIG. 13, first and second dipole arms 141,142 have a meander pattern, respectively. As the first and second dipole arms 141,142 are formed to have a zigzag shape, the size of the antenna is more reduced. As each length of the first and second dipole arms 141,142 in a Z direction is reduced, a length of connection conductors 140 for connecting inductors 143,144 to the first and second dipole arms 141,142 is reduced. Accordingly, an electromagnetic field interference between the connection conductors 140 and the first and second dipole arms 141,142 can be minimized.

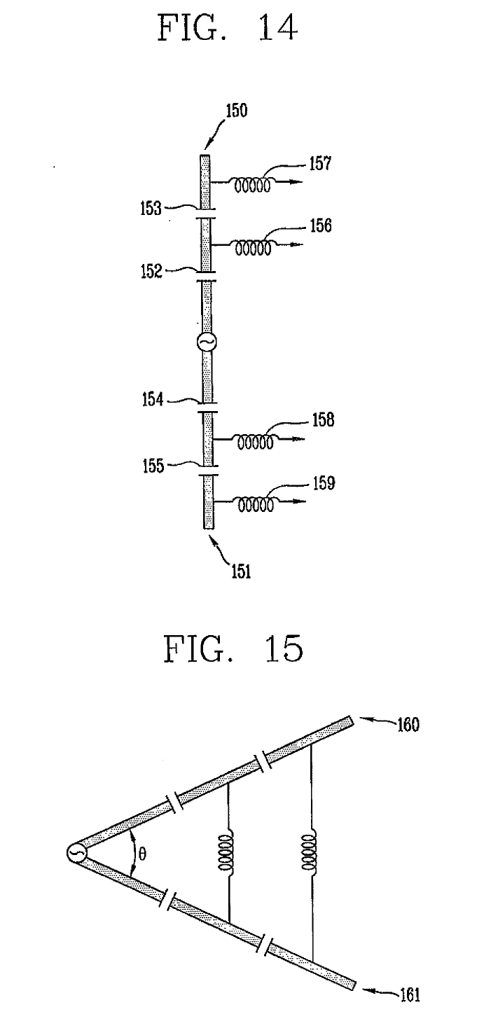

FIG. 14 is a conceptual view schematically showing an antenna according to a fifth embodiment of the present invention. Referring to FIG. 14, the antenna according to a fifth embodiment is the same as the antenna according to the first embodiment in that first to fourth capacitors 152,153,154,155 are disposed on first and second dipole arms 150,151. However, the antenna according to a fifth embodiment is different from the antenna according to the first embodiment in the number of the inductors 156,157,158,159, and in that each one end of the inductors 156,157,158,159 is grounded. More concretely, one end of the first inductor 156 is connected to the first dipole aim 150 between the first and second capacitors 152, 153, and one end of the second inductor 157 is connected between the second capacitor 153 and one end of the first dipole arm 150. And, the third inductor 158 is connected to the second dipole arm 151 between the third and fourth capacitors 154,155, and the fourth inductor 159 is connected between the fourth capacitor 155 and one end of the second dipole arm 151. Here, each another end of the first to fourth inductors 156,157,158,159 is grounded. The first to fourth inductors 156,157,158,159 respectively have both ends connected to different potentials, thereby serving as each reactance.

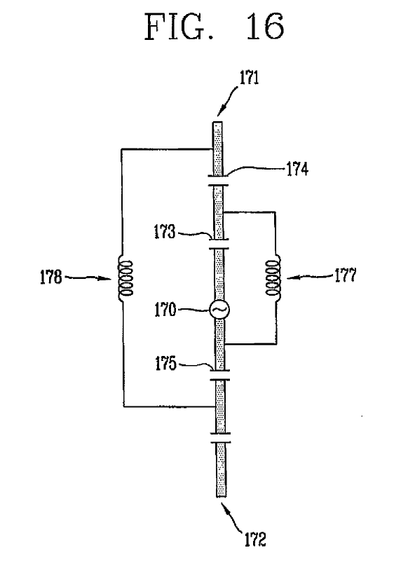

FIG. 15 is a conceptual view schematically showing an antenna according to a sixth embodiment of the present invention. Referring to FIG. 15, first and second dipole arms 160,161 are arranged to cross each other with an angle (θ) between 0° and 180°. Accordingly, a freedom degree in an installation space of the antenna is enhanced, thereby facilitating to design electronic equipment having the antenna therein.

FIG. 16 is a conceptual view schematically showing an antenna according to a seventh embodiment of the present invention. The dipole antenna of the seventh embodiment is different from the dipole antenna of the first embodiment in connection positions of both ends of each of first and second inductors 177,178 to first and second dipole arms 171,172. More concretely, one end of the first inductor 177 is connected to the first dipole arm 171 between first and second capacitors 173,174, whereas another end of the first inductor 177 is connected to the second dipole arm 172 between a feeder 170 and a third capacitor 175. One end of the second inductor 178 is connected between the second capacitor 174 and one end of the first dipole arm 171, whereas another end of the second inductor 178 is connected to the second dipole arm 172 between third and fourth capacitors 175, 176. The first and second inductors 177,178 can be connected to various parts on the first and second dipole arms 171,172 only if the respective both ends thereof are connected to different potentials.

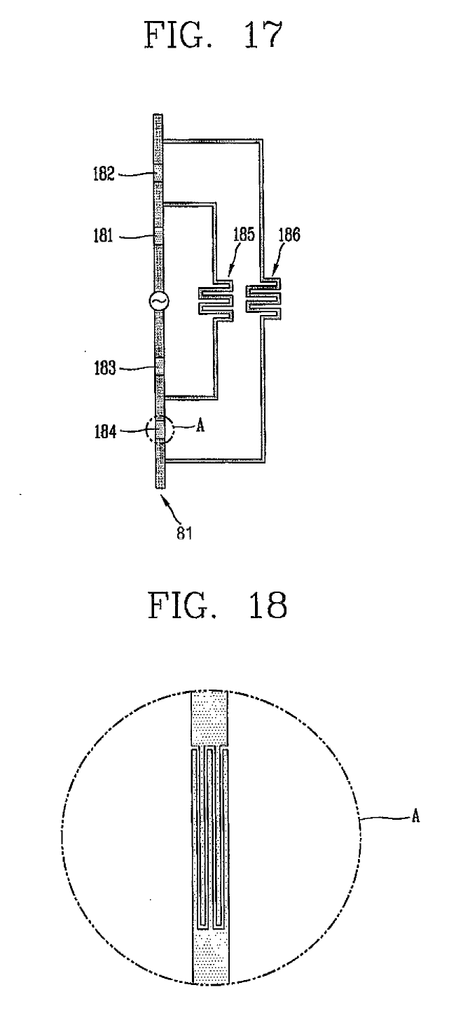

FIG. 17 is a conceptual view schematically showing an antenna according to an eighth embodiment of the present invention, and FIG. 18 is a detail view showing a part ‘A’ of FIG. 17. As shown in FIG. 18, the antenna of the eighth embodiment is different from each antenna of the first to seventh embodiments in that first to fourth capacitors 181,182,183,184 have combs-like patterns (inter-digital capacitors), and first and second inductors 185,186 have meander patterns. The capacitors 181,182,183,184 and the inductors 156,157 can be fabricated with certain patterns integrally with a radiator 180, thereby facilitating to fabricate the antenna.

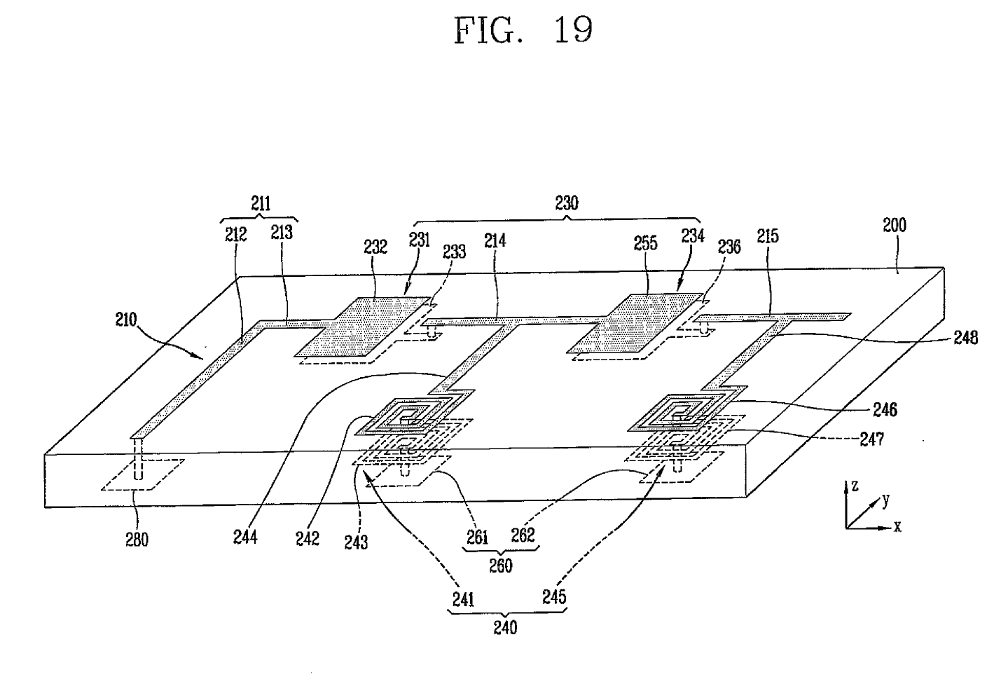

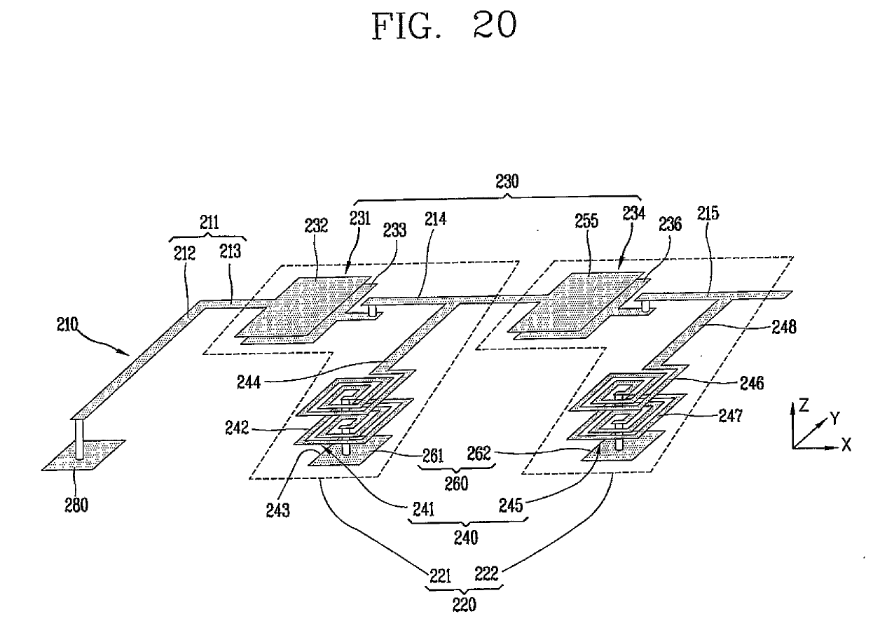

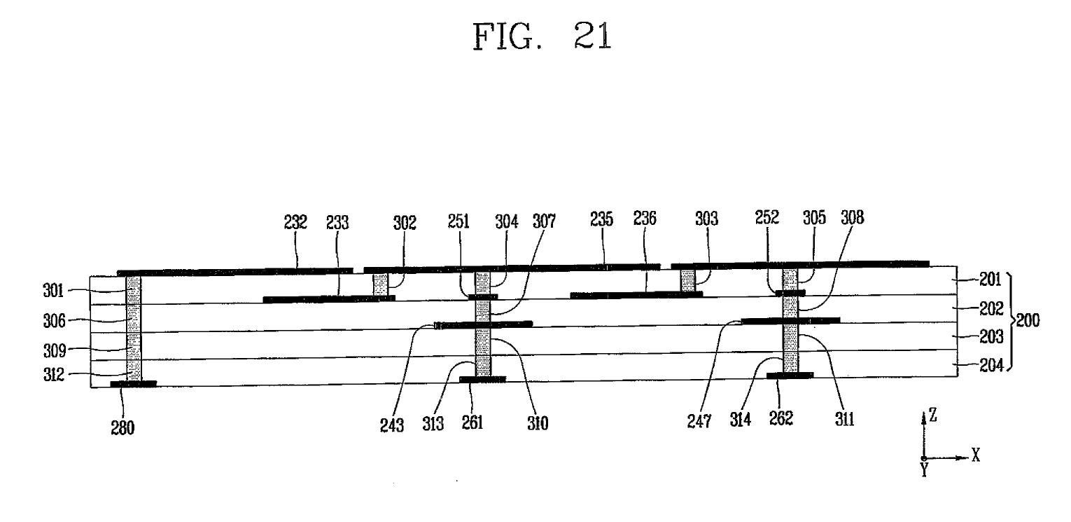

Referring to FIGS. 19 to 23, a lamination-type antenna according to a ninth embodiment of the present invention comprises a chip body 200, a radiator 210, and a reinforcing circuit 220.

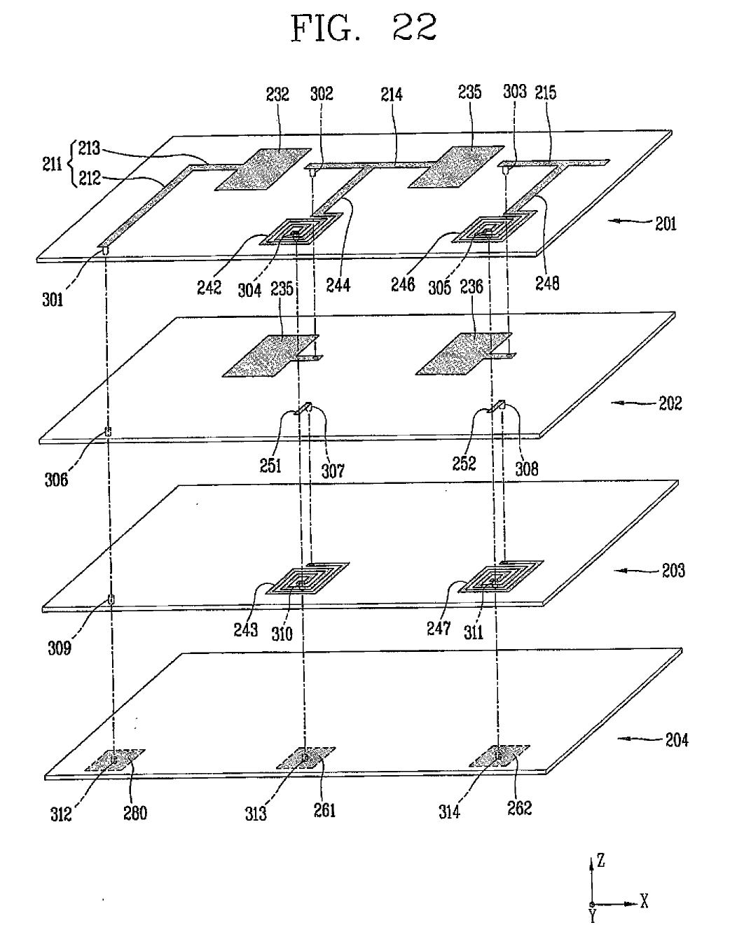

As shown in FIG. 22, the chip body 200 is formed as a plurality of substrates 201,202,203,204 are laminated to each other, and the radiator 210 and the reinforcing circuit 220 are formed inside or on an outer surface of the chip body 200.

The chip body 200 having the radiator 210 and the reinforcing circuit 220 may be fabricated by a ceramic chip fabricating technique such as an LTCC (Low Temperature Co-fired Ceramics) technique. That is, the chip body 200 is fabricated by the following processes. First, a mixed material with glass and ceramic is cut into thin green sheets (ceramic tapes), and then conductive materials such as gold, silver, or copper are printed on the respective cut green sheets so as to form the radiator 210 and the reinforcing circuit 220. Then, the ceramic and the printed conductive materials on the laminated green sheets are simultaneously fired.

The radiator 210 includes first to third radiation lines 211, 214, 215.

One end of the first radiation line 211 is electrically connected to a feeding pad 280 formed on a lower surface of the chip body 200 through via holes 301, 306, 309, 312 filled with conductive materials.

As the conductive material inside the via holes 301, 306, 309, 312, paste including a conductive phase, a binder, a vehicle, and additives may be used.

The feeding pad 280 is electrically connected to a feeder 270 through a transmission line (not shown) of a main substrate (not shown). The first radiation line 211 is bent by 90° at a certain point. More concretely, the first radiation line 211 includes a vertical portion 212 having one end connected to the conductive material inside the first via hole 301, and extending in a Y axis direction; and a horizontal portion 213 bent by 90° from another end of the vertical portion 212, and extending in an X axis direction,

The second radiation line 214 is formed on the same line as the horizontal portion 213 of the first radiation line 211. And, a first capacitor 231 of the reinforcing circuit 220 is disposed between the horizontal portion 213 of the first radiation line 211 and the second radiation line 214.

The third radiation line 215 is formed on the same line as the second radiation line 214. And, a second capacitor 234 is disposed between the second radiation line 214 and the third radiation line 215.

The reinforcing circuit 220 is implemented as one pair of circuits 221, 222, and includes a capacitor 234 and an inductor 240.

The capacitor 234 includes the first and second capacitors 231, 234.

The first capacitor 231 includes a first conductive plate 232 extending from the horizontal portion 213 of the first radiation line 211, and a second conductive plate 233 facing the first conductive plate 232. The second conductive plate 233 is spaced from the first conducive plate 232 in a thickness direction of the chip body 200, that is, the Z axis direction. Accordingly, the chip body 200, a dielectric substance, is disposed between the first and second conductive plates 232, 233, thereby serving as the capacitor. The second conductive plate 233 is electrically connected to the second radiation line 214 through the conductive material inside the second via hole 302.

The second capacitor 234 has the same shape and structure as the first capacitor 231 except for a position between the second radiation line 214 and the third radiation line 215. More concretely, first and second conductive plates 235, 236 of the second capacitor 234 are spaced from each other in a thickness direction of the chip body 200. And, the second conductive plate 236 is electrically connected to the third radiation line 215 through the conductive material inside the third via hole 303.

The inductor 240 includes a first inductor 241 connected to the second radiation line 214, and a second inductor 245 connected to the third radiation line 215.

The first inductor 241 includes one pair of spiral patterns 242, 243, and a connection line 244 for connecting one (242) of the two spiral patterns 242, 243 to the second radiation line 214.

The one pair of spiral patterns 242, 243 are composed of first and second spiral patterns 242, 243 spaced from each other in a thickness direction (the Z axis direction).

The first spiral pattern 242 is implemented in the form of coils wound oil a plane. One side of the first spiral pattern 242 is connected to the connection line 244, and as shown in FIG. 22, another side of the first spiral pattern 242 is connected to one side of the second spiral pattern 243 through the fourth and seventh via holes 304,307 filled with conductive materials and by a connection strip 251.

The second spiral pattern 243 is implemented in the form of coils wound on a different plane from the first spiral pattern 242, and is disposed to face the first spiral pattern 242. One side of the second spiral pattern 243 is electrically connected to the first spiral pattern 242 through the fourth and seventh via holes 304,307 filled with conductive materials and through a connection strip 251.

Another side of the second spiral pattern 243 is connected to a grounding pad 261 through the tenth and thirteenth via holes 310, 313 filled with conductive materials.

The second inductor 245 has the same structure as the first inductor 241 except for a connection structure to the third radiation line 215. That is, the second inductor 245 includes one pair of spiral patterns 246,247, and a connection line 248 for connecting one (246) of the two spiral patterns 246, 247 to the third radiation line 215. The one pair of spiral patterns 246,247 are composed of first and second spiral patterns 246, 247 spaced from each other in a thickness direction (the Z axis direction).

One side of the first spiral pattern 246 is connected to the connection line 248, and as shown in FIG. 22, another side of the first spiral pattern 246 is connected to one side of the second spiral pattern 247 through the fifth and eighth via holes 305,308 filled with conductive materials and through a connection strip 252. The second spiral pattern 247 is implemented in the form of coils wound on a different plane from the first spiral pattern 246, and is disposed to face the first spiral pattern 246. One side of the second spiral pattern 247 is electrically connected to the first spiral pattern 246 through the fifth and eighth via holes 305,308 filled with conductive materials and through the connection strip 252. Another side of the second spiral pattern 247 is connected to a grounding pad 262 through the eleventh and fourteenth via holes 311,314 filled with conductive materials.

In the preferred embodiment, the two capacitors 231, 234, and the two inductors 241, 245 are disposed at the radiator 210. However, three or more capacitors, and three or more inductors may be periodically arranged at the radiator 210.

Hereinafter, processes for fabricating the lamination-type antenna will be explained in more detail.

Referring to FIG. 22, first to fourth substrates 201, 202, 203, 204 are prepared, and a certain pattern is printed on each of the first to fourth substrates 201, 202, 203, 204. Then, the substrates 201, 202, 203, 204 having undergone the patterning process are laminated to one another thus to be fired. As the first to fourth substrates 201, 202, 203, 204, green sheets fabricated by an LTCC technique may be used.

First of all, a process for patterning the first substrate 201 will be explained.

The first to third radiation lines 211, 214, 215 are formed on an upper surface of the first substrate 201. Then, the first conductive plates 232, 235 are formed at each one end of the first and second radiation lines 211, 214. Then, the connection lines 244, 248 respectively connected to the second and third radiation lines 214, 215, and the first spiral patterns 242, 246 respectively connected to the connection lines 244, 248 are formed. Here, the first to fifth via holes 301, 302, 303, 304, 305 are respectively formed at another end of the first radiation line 211, one end of the second radiation line 214, one end of the third radiation line 215, and each one end of the two spiral patterns 242, 246. The first to fifth via holes 301, 302, 303, 304, 305 are filled with conductive materials.

Next, a process for patterning the second substrate 202 will be explained.

On an upper surface of the second substrate 202, the two second conductive plates 233,236 are formed in correspondence to the first conductive plates 232,235. Then, the two connection strips 251, 252 for connecting the first spiral patterns 242, 246 to the second spiral patterns 243, 247 are formed in correspondence to the first spiral patterns 242, 246. The sixth via hole 306 corresponding to the first via hole 301 formed at another end of the first radiation line 211 is formed at the second substrate 202. The seventh and eighth via holes 307, 308 are formed at each one end of the connection strips 251, 252. The second conductive plates 233, 236 are connected to the second and third radiation lines 214, 215 through the conductive materials filled inside the second and third via holes 302, 303. Also, the connection strips 251,252 are respectively connected to the first spiral patterns 242, 246 through the conductive materials filled inside the fourth and fifth via holes 304, 305.

Next, a process for patterning the third substrate 203 will be explained.

The second spiral patterns 243, 247 are formed on the third substrate 203 in correspondence to the first spiral patterns 242, 246. Each one end of the second spiral patterns 243, 247 is electrically connected to the connection strips 251, 252 through the conductive materials filled inside the seventh and eighth via holes 307, 308. The ninth via hole 309 is formed at the third substrate 203 in correspondence to the first via hole 301. The tenth and eleventh via holes 310, 311 are formed at each another end of the second spiral patterns 243, 247.

Next, a process for patterning the fourth substrate 204 will be explained.

On a lower surface of the fourth substrate 204, the feeding pad 280 is formed in correspondence to the ninth via hole 309, and the grounding pads 261, 262 are formed in correspondence to the second spiral patterns 243, 247. The twelfth via hole 312 corresponding to the ninth via hole 309 is formed at the feeding pad 280. The thirteenth and fourteenth via holes 313, 314 are respectively formed at the grounding pads 261, 262 in correspondence to the tenth and eleventh via holes 310, 311.

An electric connection status to the laminated substrates 201, 202, 203, and 204 will be explained.

The first radiation line 211 is electrically connected to the feeding pad 280 through the conductive materials filled inside the first, seventh, ninth, and twelfth via holes 309, 310, 311, 312. The second and third radiation lines 214, 215 are electrically connected to the second conductive plates 233, 236 through the second and third via holes 302, 303. The first spiral patterns 242, 246 are electrically connected to the connection strips 251, 252 through the conductive materials filled inside the fourth and fifth via holes 304, 305. And, the connection strips 251, 252 are electrically connected to the second spiral patterns 243, 247 through the conductive materials filled inside the seventh and eighth via holes 307, 308. The second spiral patterns 243, 247 are respectively connected to the grounding pads 261, 262 through the conductive materials filled inside the tenth and thirteenth via holes 310, 313, and the eleventh and fourteenth via holes 311, 314.

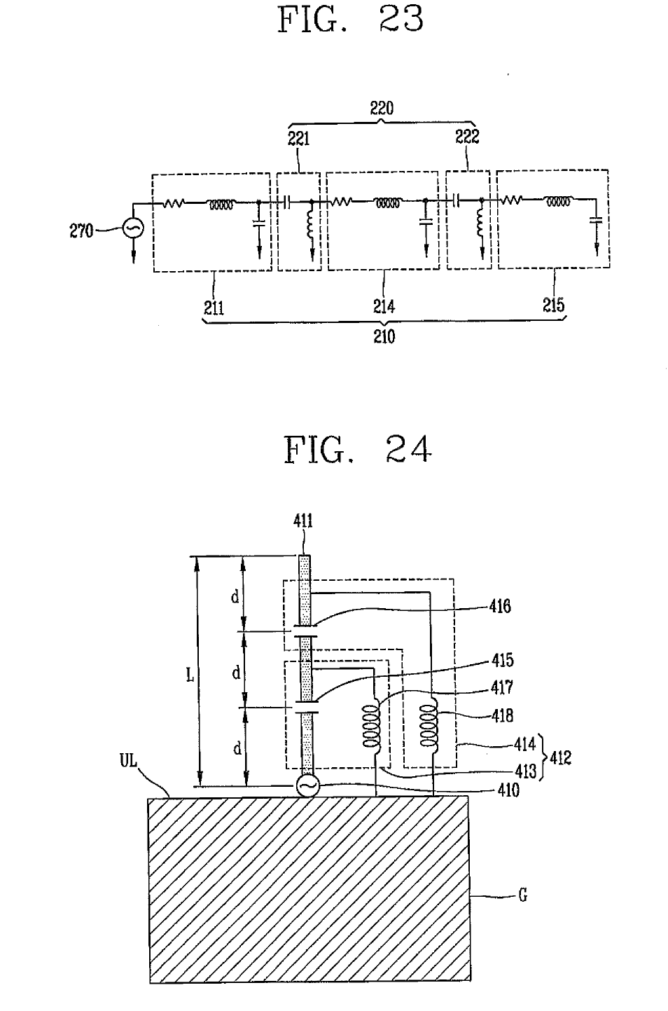

Referring to FIG. 24, a monopole antenna according to a tenth embodiment of the present invention is disposed on a ground plane (G). The monopole antenna comprises a radiator 411 electrically connected to a feeder 410, and one or more reinforcing circuits 412 disposed in the radiator 411 so as to uniformly distribute a current on at least one part of the radiator 411.

The ground plane (G) is implemented as a conductive material is deposited on one surface of a printed circuit board inside electronic equipment.

The feeder 410 supplies a current to the radiator 411 through a signal pattern on the printed circuit board.

The radiator 411 is formed of a conductive material, and is disposed on the ground plane (G). The radiator 411 is fabricated so as to have a length corresponding to approximately 1/40 of a wavelength of an operation frequency.

As aforementioned, when the monopole antenna has a quarter wavelength of a wavelength of an operation frequency, a resonance does not occur at the operation frequency. Accordingly, if the monopole antenna has no reinforcing circuit 412 at the radiator 411, a resonance does not occur near the operation frequency (200 MHz) as shown by the dotted line of FIG. 2.

As shown in FIG. 3A, since both ends of the radiator 1 are opened, a resistance applied to the both ends becomes unlimited thus to have a current value of ‘0’. A current distribution is shown with a sine form from both ends of the radiator 1 to the feeder 2. However, since a length (L) of the radiator 1 is short enough to be about 1/40 of a wavelength of an operation frequency, a current distribution on the radiator 1 is linearly decreased near ‘0’. Since a resonance does not occur at the operation frequency and an amount of current is approximately ‘0’, a strength of an electric wave is weak at the operation frequency. Furthermore, since a current distribution is linearly decreased, a reflection coefficient is increased thus not to emit current on the radiator in an electric wave form but to be reflected.

In the present invention, since the reinforcing circuit 412 is provided in the radiator 411, a characteristic of the radiator 411 is changed. Accordingly, a current distribution is changed, and the amount of current applied to the radiator 411 is changed. Hereinafter; the reinforcing circuit 412 will be explained.

The reinforcing circuit 412 serves to increase the amount of current applied to the radiator 411, and to uniformly distribute on the radiator 411. The reinforcing circuit 412 is periodically arranged at the radiator 411 in plurality in number. In the preferred embodiment, two reinforcing circuits 413,414 are provided. The reinforcing circuits 413,414 respectively include first and second capacitors 415, 416 disposed with a certain gap (d) therebetween, and first and second inductors 417, 418 having one end connected to the radiator 411 and another end connected to the ground plane (G).

The first and second capacitors 415,416 preferably have the same capacitance, but may have different capacitance for impedance matching. The first and second capacitors 415, 416 are arranged with a certain gap (d) therebetween, but may have a different gap therebetween so as to optimize an antenna function.

One end of the first inductor 417 is connected to the radiator 411 between the first and second capacitors 415, 416, and another end of the first inductor 417 is connected to the ground plane (G) thus to be grounded.

One end of the second inductor 418 is connected to the radiator 411 between the second capacitor 416 and one end of the radiator 411, and another end of the second inductor 418 is connected to the ground plane (G) thus to be grounded. Both ends of each of the first and second inductors 417,418 are connected to different potentials, thereby serving as a reactance on an equivalent circuit as shown in FIG. 5B.

The first and second inductors 417,418 preferably have the same inductance, but may have different inductance so as to optimize an antenna function.

As the capacitors 415,416 and the inductors 417,418, lumped elements are preferably used. However, distributed elements having varied sizes such as microstrips may be used.

In the monopole antenna according to the tenth embodiment, the two reinforcing circuits 413, 414 are arranged. However, three or more reinforcing circuits may be arranged at the radiator 411.

FIG. 25 is a conceptual view schematically showing a monopole antenna according to an eleventh embodiment of the present invention. The monopole antenna of the eleventh embodiment is different from that of the tenth embodiment in that a part of a radiator 420 is bent so as to be parallel to an upper end line (UL) of a ground plane (G). That is, the radiator 420 includes a vertical portion 421 disposed in a direction perpendicular to the upper end line (UL) of the ground plane (G), and a horizontal portion 422 bent by 90° from the vertical portion 421 so as to be parallel to the upper end line (UL) of the ground plane (G). First and second capacitors 423, 424 are arranged at the horizontal portion 422 with a certain gap therebetween, and first and second inductors 425, 426 are arranged in parallel between the horizontal portion 422 and the ground plane (G). More concretely, the first inductor 425 has one end connected to the horizontal portion 422 between the first and second capacitors 423, 424, and another end connected to the ground plane (G). The second inductor 426 has one end connected between the second capacitor 424 and one end of the horizontal portion 422, and another end grounded to the ground plane (G). As the radiator 420 is bent, the antenna has a reduced size. In the eleventh embodiment, a length of connection conductors (not shown) for connecting the first and second inductors 425, 426 between the horizontal portion 422 and the ground plane (G) can be shortened. As the connection conductor has a shortened length, an electromagnetic field interference between the connection conductor and the radiator 420 can be minimized.

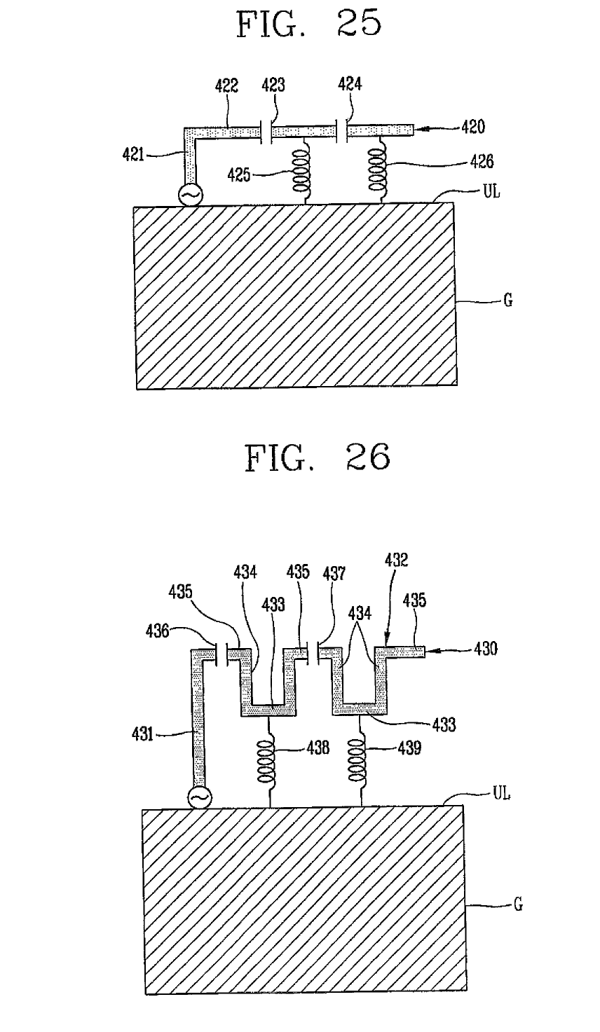

FIG. 26 is a conceptual view schematically showing a monopole antenna according to a twelfth embodiment of the present invention. Referring to FIG. 26, a horizontal portion 432 of a radiator 430 has a meander pattern in a direction to be adjacent or spaced to/from a ground plane (G). As the horizontal portion 432 is formed to have a meander pattern, an entire length of the antenna can be shortened with maintaining an electric length of the radiator 430. Accordingly, the antenna can be more miniaturized.

The horizontal portion 432 includes a horizontal adjacent portion 433 adjacent to the ground plane (G), a horizontal spaced portion 435 spaced from the horizontal adjacent portion 433 in a direction to be far from the ground plane (G), and a plurality of connection portions 434 for connecting the horizontal adjacent portion 433 and the horizontal spaced portion 435 to each other.

The first and second inductors 438,439 respectively have one end connected to the horizontal adjacent portion 433, and another end connected to the ground plane (G). Accordingly, a length of connection conductors for connecting the first and second inductors 425, 426 to the radiator 430 is shortened, and thus an electromagnetic field interference between the connection conductor and the radiator 430 can be minimized. First and second capacitors 436, 437 are arranged at the horizontal spaced portion 435, respectively.

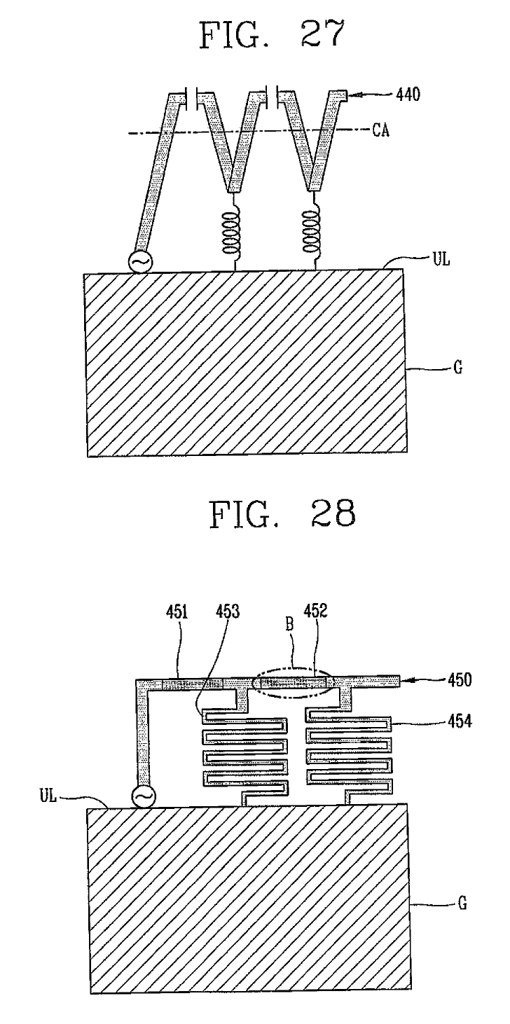

FIG. 27 is a conceptual view schematically showing a monopole antenna according to a thirteenth embodiment of the present invention. Referring to FIG. 26, a radiator 440 is formed in a helical shape having a center line (CA) parallel to an upper end line (UL) of a ground plane (G). As the radiator 440 has a helical shape, the antenna can have a high gain in a wide range of frequencies, and can be more miniaturized.

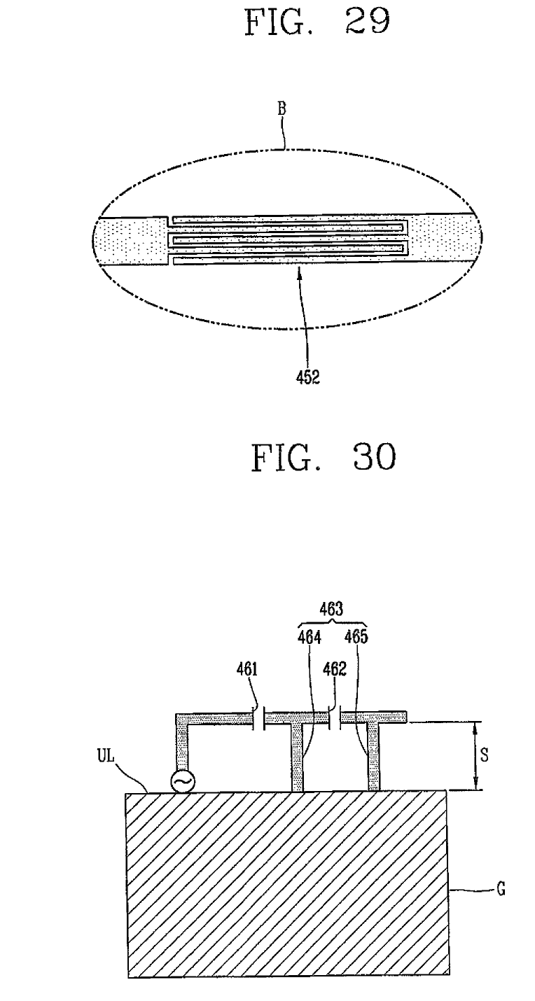

FIGS. 28 and 29 are conceptual views schematically showing a monopole antenna according to a fourteenth embodiment of the present invention. As shown in FIG. 29, the antenna of the fourteenth embodiment is different from each antenna of the first to thirteenth embodiments in that first and second capacitors 451, 452 have combs-like patterns (inter-digital capacitors), and first and second inductors 453, 454 have meander patterns. The capacitors 451,452 and the inductors 453,454 can be integrally fabricated with a radiator 450 by being inserted into the radiator 450. Accordingly, the antenna can be more easily fabricated.

FIG. 30 is a conceptual views schematically showing a monopole antenna according to a fifteenth embodiment of the present invention. As shown in FIG. 30, the antenna of the fifteenth embodiment is different from the antenna of the eleventh embodiment in that a shorting stub 463 is used instead of the lumped inductor. When a length (S) of the shorting stub 463 is equal to or less than a quarter wavelength of a wavelength of an operation frequency, the shorting stub 463 serves as an inductor. The shorting stub 463 includes a first stub 464 for connecting a radiator 61 between first and second capacitors 461, 462 to a ground plane (G), and a second stub 465 for connecting the radiator 61 between the second capacitor 416 and one end of the radiator 61 to the ground plane (G). As the shorting stub 463 is used instead of the lumped inductor, the antenna can be more easily fabricated.

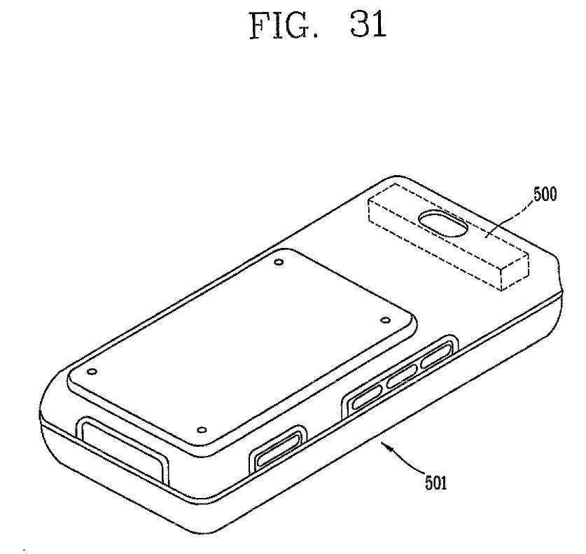

FIG. 31 is a view schematically showing that the antenna of the present invention is mounted in electronic equipment.

As aforementioned, an antenna 500 according to the preferred embodiment of the present invention may be mounted in all electronic equipment that can perform a wireless communication.

The antenna of the present invention may be mounted in electronic equipment, such as a terrestrial DMB terminal 501 operated at a low frequency bandwidth (less than 1 GHz) and implementing a reduced antenna length with maintaining the same antenna function.

The antenna of the present invention may be applied not only to the terrestrial DMB terminal, but also to various electronic equipment such as a portable phone, a PDA (Personal Digital Assistants), a car navigator, a notebook computer, a data recording, reproducing and displaying machine, an electronic dictionary, an MP3 player, an MD player, a radio, an audio, etc.

The antenna of the present invention has the following effects.

First, since the reinforcing circuit composed of the capacitor and the inductor is arranged in the radiator, a current is uniformly distributed to at least one part of the radiator, and thereby a radiation resistance of the antenna is increased. By the increased radiation resistance, radiation power and efficiency of the antenna are enhanced.

Second, since the radiation resistance is increased, a reflection coefficient is lowered thus to enhance efficiency and a bandwidth of the antenna.

Third, since the amount of current applied to the radiator is increased by the reinforcing circuit inside the radiator, the radiation power is increased thus to enhance the efficiency of the antenna.

That is, an entire length of the antenna can be shortened than a wavelength of an operation frequency with maintaining the same efficiency. Accordingly, the antenna can be mounted in electronic equipment such as a terrestrial DMB terminal operated at a low frequency bandwidth.

Fourth, since the impedance matching unit is arranged on the transmission line for connecting the feeder and the radiator to each other, the amount of current applied to the radiator can be maximized.

Fifth, since the first and second dipole arms are disposed in parallel, the connection conductors for connecting the inductors to the first and second dipole arms have a shortened length. Accordingly, an electromagnetic field interference between the connection conductors and the first and second dipole arms is minimized, thereby enhancing the efficiency of the antenna.

Sixth, since the first and second dipole arms are formed to have a meander pattern, the antenna can be miniaturized, and the connection conductors for connecting the inductors to the first and second dipole arms have a shortened length. Accordingly, an electromagnetic field interference between the connection conductors and the first and second dipole arms is minimized.

Seventh, since the first and second dipole arms are arranged to have an angle therebetween, a freedom degree for an installation space of the antenna mounted in electronic equipment is enhanced. Accordingly, the electronic equipment having the antenna therein can be easily fabricated.

Eighth, since the capacitors have combs-like patterns (inter-digital capacitors) and the inductors have meander patterns, the antenna can be easily fabricated.

Ninth, the lamination-type antenna does not require additional processes for cutting and bending a plate-type antenna. Accordingly, the antenna can be easily fabricated, can enhance productivity, and can be easily installed in electronic equipment due to its conformal pattern.

Tenth, in case that the shorting stub serves as the inductor, the antenna can be more easily fabricated.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An antenna, comprising:
a radiator electrically connected to a feeder, and configured to radiate an electric wave; and
one or more reinforcing circuits disposed in the radiator so as to uniformly distribute a current on at least one part of the radiator.

2. The antenna of claim 1, wherein the reinforcing circuit comprises:
one or more capacitors disposed in the radiator; and
one or more inductors having one end connected to the radiator, and another end connected to a circuit different from the radiator.

3. The antenna of claim 1, wherein the radiator is implemented to be linear, and a length of the radiator is equal to or less than 1/20 of a wavelength of an operation frequency.

4. The antenna of claim 1, further comprising an impedance matching unit disposed on a transmission line between the feeder and the radiator.

5. The antenna of claim 1, wherein the reinforcing circuit is disposed at the radiator so as to increase an amount of current applied to the radiator.

6. A dipole antenna, comprising:
first and second dipole arms electrically connected to a feeder and having different potentials from each other; and
a reinforcing circuit electrically connected to at least one of the first and second dipole arms so as to uniformly distribute a current on at least one of the first and second dipole arms.

7. The dipole antenna of claim 6, wherein the reinforcing circuit comprises:
first and second capacitors disposed on the first dipole arm with a predetermined gap therebetween;
third and fourth capacitors disposed on the second dipole arm with the same gap therebetween as the first and second capacitors;
a first inductor having one end connected to the first dipole arm between the first and second capacitors, and another end connected to the second dipole arm between the third and fourth capacitors; and
a second inductor having one end connected between the second capacitor and one end of the first dipole arm, and another end connected between the fourth capacitor and one end of the second dipole arm.

8. The dipole antenna of claim 7, wherein the first to fourth capacitors have substantially same capacitance, and the first and second inductors have substantially same inductance.

9. The dipole antenna of claim 7, wherein the first to fourth capacitors have combs-like patterns, and the first and second inductors have meander patterns.

10. The dipole antenna of claim 6, wherein the first and second dipole arms are disposed in parallel to each other.

11. The dipole antenna of claim 6, wherein the first and second dipole arms have a meander pattern.

12. The dipole antenna of claim 6, wherein the reinforcing circuit comprises:
a plurality of capacitors disposed in the first and second dipole arms; and
one or more inductors having one end connected to at least one of the first and second dipole arms, and another end being grounded.

13. The dipole antenna of claim 6, wherein the first and second dipole arms are arranged to cross each other with an angle between 0° and 180°.

14. The dipole antenna of claim 6, wherein the reinforcing circuit comprises:
first and second capacitors disposed on the first dipole arm with a predetermined gap therebetween;
third and fourth capacitors disposed on the second dipole arm with the same gap therebetween as the first and second capacitors;
a first inductor having one end connected to the first dipole arm between the first and second capacitors, and another end connected to the second dipole arm between the third capacitor and the feeder; and
a second inductor having one end connected between the second capacitor and one end of the first dipole arm, and another end connected to the second dipole arm between the third and fourth capacitors.

15. The dipole antenna of claim 6, comprising:
a plurality of capacitors connected to the first and second dipole arms in series; and
a plurality of inductors respectively having both ends connected to the first and second dipole arms in parallel.

16. A lamination-type antenna, comprising:
a chip body;
a radiator formed at the chip body, and electrically connected to a feeder; and
a reinforcing circuit disposed in the radiator so as to uniformly distribute a current on at least one part of the radiator.

17. The lamination-type antenna of claim 16, wherein the radiator comprises:
first and second radiation lines electrically separated from each other, wherein the reinforcing circuit comprises:
a capacitor disposed between the first and second radiation lines; and
an inductor having one side connected to the second radiation line and another end being grounded, and wherein the capacitor comprises:
a first conductive plate extending from the first radiation line; and
a second conductive plate facing the first conductive plate, spaced from the first conducive plate in a thickness direction of the chip body, and electrically connected to the second radiation line.

18. The lamination-type antenna of claim 17, wherein the inductor comprises:
a first spiral pattern having one end electrically connected to the second radiation line; and
a second spiral pattern spaced from the first spiral pattern in a thickness direction of the chip body, the second spiral pattern having one end electrically connected to another end of the first spiral pattern, and having another end being grounded.

19. The lamination-type antenna of claim 18, comprising:
a grounding pad electrically connected to the second spiral pattern; and
a feeding pad to which the first radiation line is electrically connected, wherein the feeding pad is electrically connected to the feeder.

20. A monopole antenna, comprising:
a radiator electrically connected to a feeder, and disposed on a ground plane of a finite plane; and
a reinforcing circuit disposed in the radiator so as to uniformly distribute a current on at least one part of the radiator, and connected to the ground plane.

21. The monopole antenna of claim 20, wherein the radiator comprises:
a vertical portion disposed in a direction perpendicular to an upper end line of the ground plane; and
a horizontal portion disposed in parallel to the upper end line of the ground plane, wherein the reinforcing circuit comprises:
a plurality of capacitors disposed at the horizontal portion in series with a predetermined gap therebetween; and
a plurality of inductors disposed in parallel between the horizontal portion and the ground plane.

22. The monopole antenna of claim 20, wherein the radiator comprises:
a vertical portion disposed in a direction perpendicular to an upper end line of the ground plane; and
a horizontal portion disposed in parallel to the upper end line of the ground plane, wherein the horizontal portion comprises:
one or more horizontal adjacent portions adjacent to the ground plane;
one or more horizontal spaced portions spaced from the one or more horizontal adjacent portions in a direction to be away from the ground plane; and
one or more connection portions for connecting the one or more horizontal adjacent portions to the one or more horizontal spaced portions, and wherein the reinforcing circuit comprises:
one or more capacitors disposed at the one or more horizontal spaced portions; and
one or more inductors disposed between the one or more horizontal adjacent portions and the ground plane.

23. The monopole antenna of claim 20, wherein the radiator is formed in a helical shape having a center line (CA) parallel to an upper end line of the ground plane.

24. Electronic equipment having an antenna for transmitting and receiving an electric wave, wherein the antenna comprises:
a radiator electrically connected to a feeder, and configured to radiate an electric wave; and
one or more reinforcing circuits disposed in the radiator so as to uniformly distribute a current on at least one part of the radiator.

25. The electronic equipment of claim 24, wherein the electronic equipment is implemented as one of a terrestrial DMB terminal, a portable phone, a portable computer, an MP3 player, an MD player, a radio, and an audio device.

26. A mobile communication terminal comprising:
an antenna configured to transmit and receive signals; and
a processor configured to process the signals,
wherein the antenna comprises:
a radiator configured to radiate an electric wave and including first and second dipole arms, and
at least one reinforcing circuit arranged on the first and second dipole arms.
